(19) United States
(12) Patent Application Publication
(10) Pub. No.: US 2019/0311453 A1
(43) Pub. Date: Oct. 10, 2019

(54) System and Method for Between-Ride Routing for Transportation Providers

(71) Applicant: Massachusetts lnstitute of Technology, Cambridge, MA (US)

(72) Inventors: Ian Schneider, Somerville, MA (US); Jun Jie Joseph Kuan, Cambridge, MA (US)

(21) Appl. No.: 15/949,334

(22) Filed: Apr. 10, 2018

(51) Int. Cl. G06Q 50/30; G06Q 10/06; G01C 21/34

(52) U.S. Cl. CPC G06Q 50/30; G01C 21/3438; G06Q 10/06315

(57) ABSTRACT

A system for between-ride routing on a map for a driver of a vehicle of a transportation provider includes a receiver configured to receive driver data from a driver communication device and passenger data from a passenger communication device of a prospective passenger via a communication network. The driver data includes a driver location and the passenger data includes a prospective passenger location. A routing module is configured to access the driver data and a forecast output to calculate a turn direction for the driver at a map node based on the driver location.

### FIELD OF THE INVENTION

The present invention relates to transportation systems, and more particularly, is related to improving efficiency in ground transportation routes.

### BACKGROUND OF THE INVENTION

Transportation Network Company (TNC) drivers are paid for each ride they complete for the time/distance with a rider (paying passenger), so when a driver is between rides he has an incentive to find a new ride as quickly as possible. After discharging a rider, the TNC driver may, for example, choose to remain stationary until a prospective rider requests a ride, choose to drive to a location where there may be a prospective rider, choose to drive to a neutral location that provides a short route to two or more locations where there may be a prospective rider, or may choose a different route for a different reason. However, if the driver does not make an optimal decision, excessive fuel may be consumed and additional time may be added between riders. Therefore, there is a need in the industry to address one or more of these issues.

### SUMMARY OF THE INVENTION

Embodiments of the present invention provide a system and method for between-ride routing for transportation providers. Briefly described, the present invention is directed to a system for between-ride routing on a map for a driver of a vehicle of a transportation provider. A receiver is configured to receive driver data from a driver communication device and passenger data from a passenger communication device of a prospective passenger via a communication network. The driver data includes a driver location and the passenger data includes a prospective passenger location. A routing module is configured to access the driver data and a forecast output to calculate a turn direction for the driver at a map node based on the driver location.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a schematic diagram of a first embodiment of a system for between-ride routing for transportation providers.

FIG. 2 is a schematic diagram of a second embodiment of a system for between-ride routing for transportation providers.

FIG. 3 is a schematic diagram detailing the central system of the system of FIGS. 1 and 2.

FIG. 4 is a schematic diagram of a third embodiment of a system for between-ride routing for transportation providers.

FIG. 5 is a schematic diagram illustrating an example of a system for executing functionality of the present invention.

FIG. 6 is a flowchart of an exemplary first method embodiment for executing the functionality of the systems shown in FIGS. 1-4.

FIG. 7A is pseudocode for a first algorithm for processing all nodes under an exemplary second embodiment for executing the functionality of the systems shown in FIGS. 1-4.

FIG. 7B is pseudocode for a second algorithm for generating a preferred path based on directions at each intersection under the exemplary second embodiment.

FIG. 8 is a flowchart for the exemplary second embodiment of FIGS. 7A and 7B.

### DETAILED DESCRIPTION

The following definitions are useful for interpreting terms applied to features of the embodiments disclosed herein, and are meant only to define elements within the disclosure.

As used within this disclosure, a “map” refers to an application programming interface (API) for data representing geographic information indicating vehicle routes and/or geographical locations within a geographic region. The map may be used to display a graphical representation of a geographic region, for example, by a mapping application. The map may also be used to generate driving directions, for example turn-by-turn driving directions, as text (for example, a text message, an email message, and/or a text string presented via an application), audio, and/or graphical representation.

As used herein, “mapping” refers to correlating a geographical location according to the map.

A “node” refers to a geographical location according to a map, and a “route” or “path” refers to a set of roads that connect a first end node and a second end node. For simplicity, roads, streets, avenues, highways, and other traffic conduits available to drivers are collectively referred to herein as “roads” in a “road network.” There may be multiple intermediate nodes between the end nodes, where each intermediate node represents a specific point along a road or an intersection of two or more roads where a driver might face a choice between two or more roads, referred to herein as a “turn.”

A “rider” or “passenger” refers to a customer of the TNC. A rider/passenger who is not presently paired with a driver may be referred to as a prospective rider/passenger. A driver who is not currently paired with a paying rider is referred to as a between-ride driver. A “ride” refers to a period of time when a passenger is paying a driver for transportation.

Reference will now be made in detail to embodiments of the present invention, examples of which are illustrated in the accompanying drawings. Wherever possible, the same reference numbers are used in the drawings and the description to refer to the same or like parts.

Exemplary embodiments of the present invention describe a system and method to route between-rider TNC drivers who participate in a TNC marketplace. The embodiments take an open-ended approach to routing that may not explicitly use a destination when providing optimal turn-by-turn directions to the between-rider TNC driver. The turn-by-turn directions may be with or without a destination. Providing turn-by-turn driving directions without a destination may improve resource efficiency for transportation providers, reduce between-passenger downtime for drivers, and reduce wait time for prospective passengers. The system and method utilize a Dynamic Programming (DP) optimization solution. While DP has been used for other applications, it has not previously been considered suitable for application to optimization of between-rider driver activity in transportation networks.

The embodiments described herein may treat price and wait duration as inputs determined at the present time for the range of map locations in a particular geographic area. The output provides provably optimal directions, for example, to maximize driver profits, taking into account fuel costs, driver preferences and availability, passenger request rates, among other factors.

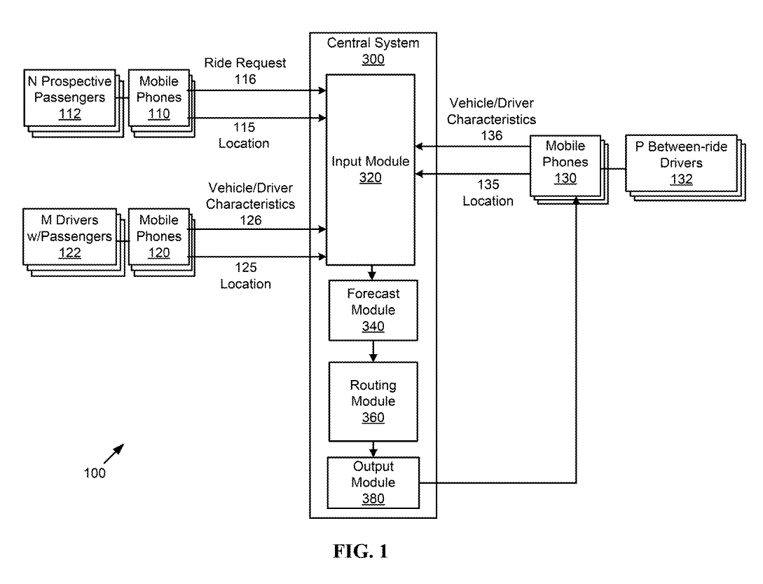

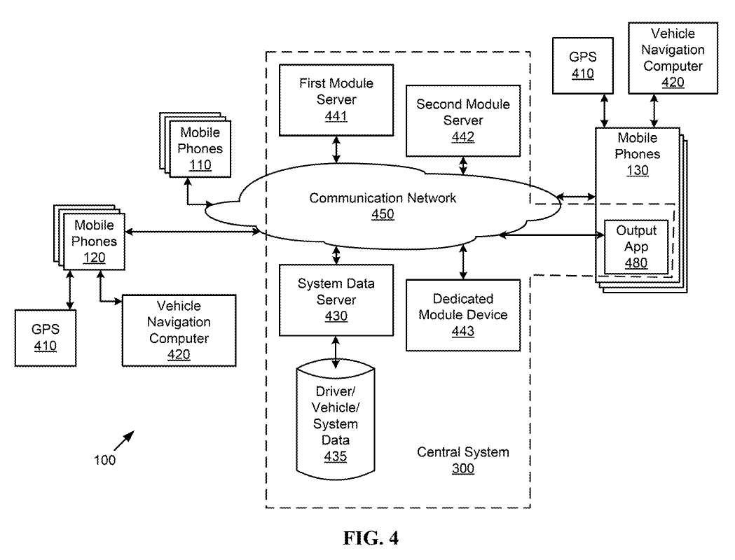

FIG. 1 is a schematic diagram of a first embodiment of a system 100 for between-ride routing for transportation providers. A central system 300 may be, for example, a server at a central office of a TNC. The central system 300 includes an input module 320 configured to receive data from prospective passengers 112, drivers with passengers 122, and between-ride drivers 132. Under the first embodiment, the prospective passengers 112, drivers with passengers 122, and between-ride drivers 132 may interact with the central system 300 via mobile phones 110, 120, 130, although in alternative embodiments the prospective passengers 112, drivers with passengers 122, and between-ride drivers 132 may interact with the central system 300 via other means, for example, computing devices in communication with the central system 300 via a communication network 450 (FIG. 4). The computing devices may be, for example, smart phones, tablet computers, laptop computers, desktop computer, and other computing devices. The computing devices may host local applications that communicate with the central system 300 via the communication network 450 (FIG. 4), or the computing devices may merely host a web browser that provides an interface to a web based application. The web based application may be hosted on the same server as the central system 300, or on a different server, for example, a cloud based server.

Each of N prospective passengers 112 provides passenger data to the input module 320 of the central system 300 via a corresponding one of N mobile phones 110. The input module 320 receives passenger information such as a passenger identifier and/or an associated account number (if any), and a ride request 116 with associated trip parameters, for example a pickup location 115 for the passenger, a desired pickup time, a number of passengers in the party, and a desired destination, among other trip parameters. The passenger data may be collected via a passenger application hosted by the mobile phone 110 of the prospective passenger 112. Alternatively, the passenger data may be collected via a web based passenger application accessed from a browser application hosted by the mobile phone 110 of the prospective passenger 112. Data may be retained by the central system 300, so data collected from prospective passengers who were previously matched with drivers or who have since terminated their data connection may still be used by the central system 300.

The TNC drivers 122, 132 similarly may use an application hosted by a mobile phone 120, 130 or computer to communicate with the input module 320 of the central system 300. For purposes of clarity, the TNC drivers are characterized herein as a group of M drivers with passengers 122, and a group of P between-ride drivers 132. The group of M drivers with passengers 122, and the group of P between-ride drivers 132 may both be communicating with the input module 320 via the same driver application on their mobile phones 120, 130. For example, the driver application may periodically report the location 125, 135 of the driver, and the status of whether the driver presently has a passenger in his vehicle. For example, a between-ride driver 132 may pick up a passenger, and thereby transition from the group of P between-ride drivers 132 to the group of M drivers with passengers 122. Likewise a driver with a passenger may discharge that passenger, and thereby transition from the group of M drivers with passengers 122 to the group of P between-ride drivers 132.

Each TNC driver 122, 132 may be assigned identifier that is associated with vehicle/driver characteristics 126, 136 including vehicle characteristics of the vehicle driven by the driver 122, 132 and characteristics of the driver 122, 132 himself. For example, vehicle characteristics may include the make and model of the vehicle, the maintenance history of the vehicle, the fuel efficiency of the vehicle, its mileage, passenger capacity, and present operating parameters, among others. Driver characteristics may include the number of hours per day the driver is operating a vehicle, the number of passengers for the driver in a given span of time (day/week/month), the average amount of between-rider time, and so forth. Data associated with vehicle/driver characteristics 126, 136 may be periodically updated by the driver application on the mobile phones 120, 130 and reported to the input module 320. For example, the driver application may report vehicle location information 125, 135 based on Global Positioning System (GPS) location, for example, via a GPS application on the mobile phone 120, 130 or another GPS device 410 (FIG. 4) and report vehicle speed and direction information based on GPS data and/or an interface with a vehicle navigation computer 420 (FIG. 4).

The input module 320 receives information from the mobile phones 110 of the N prospective passengers 112, the mobile phones 120 of the M drivers with passengers 122, and the mobile phones 130 of the P between-ride drivers 132. The information may include, for example but not limited to, passenger ride requests 116 and associated passenger location 115, and vehicle/driver characteristics 126, 136 and associated driver locations 125, 135. The input module 320 may receive information reported autonomously (periodically and/or spuriously), based on events, and/or may query the mobile phones 110, 120, 130 periodically and/or on an as needed basis. For example, the mobile phones 120 of the M drivers with passengers 122, and the mobile phones 130 of the P between-ride drivers 132 may be configured to transmit vehicle/driver characteristics 126, 136 and/or location 125, 135 to the input module 32 when they detect that the vehicle has stopped, or has begun moving after a period of being stationary.

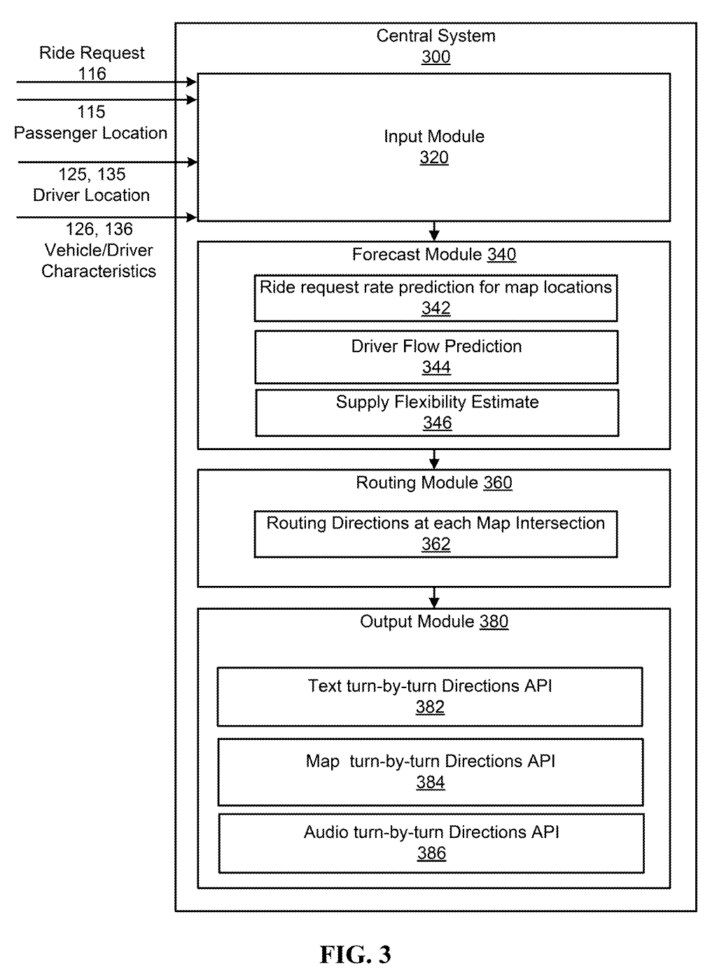

FIG. 3 is a block diagram indicating the functionality of the central system 300. Information collected by the input module 320 may available to other modules within the central system 300, for example, a forecast module 340, a routing module 360, and an output module 380. The forecast module 340 may access information gathered by the input module 320 and produce a ride request rate prediction for map locations 342, a driver flow prediction 344, and a supply flexibility estimate 346. Each of the ride request rate prediction for map locations 342, the driver flow prediction 344, and the supply flexibility estimate 346 may be used to help generate the expected revenue from a pickup at a particular location R and the expected time until a passenger request at a particular location Q, by projecting the underlying values in the future. The driver flow prediction 344 and the supply flexibility estimate 346 may also be used to update the expected time to travel along roads, which is incorporated in the routing module 360. As described further below, the routing module 360 may access the ride request rate prediction for map locations 342, the driver flow prediction 344, and the supply flexibility estimate 346 to produce routing directions at each map intersection 362 indicating a desired course to be taken by the driver at each route intersection (map node).

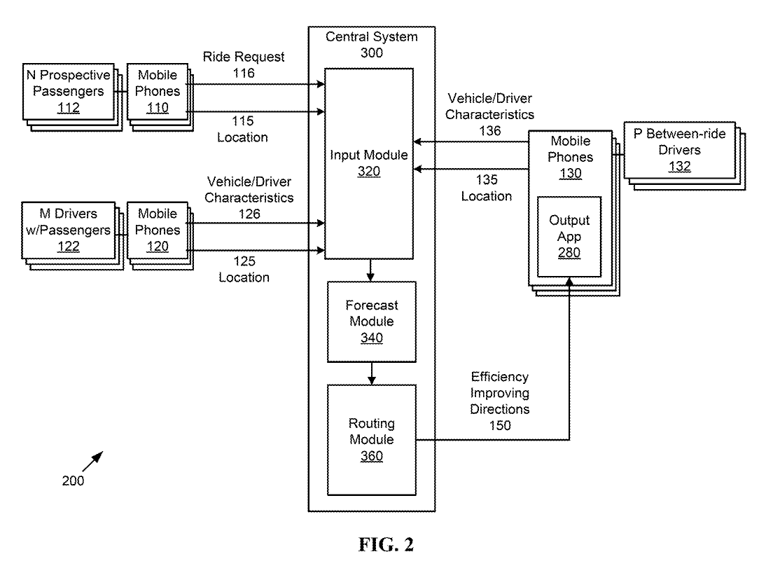

As shown in FIG. 2, under a second embodiment 200 of a system for between-ride routing for transportation providers, the functionality of the output module 380 (FIG. 1) may be implemented on the driver mobile phones 130, for example by an output app 280 hosted on the driver mobile phones 130. Similarly, while the modules 320, 340, 360, 380 of the central system 300 are depicted in FIGS. 1 and 3 as being within a single block, this is not intended to indicate that the functionality of any one or all of the modules 320, 340, 360, 380 of the central system 300 is restricted to being located within a single physical device, for example, a server, or a dedicated hardware processor, but may instead be distributed across two or more servers and/or devices, including mobile phones, and the two or more servers and/or devices may be located in different physical locations, for example, communicating via a wired or wireless communication network 450 (FIG. 4).

Under a third embodiment shown in FIG. 4, the functionality of the central system 300 (FIG. 3) may be distributed across two or more servers, for example a first module server 441 and a second module server 442, a dedicated module hosting device 443 configured to implement part or all of the functionality of one or more of modules 320, 340, 360, 380, a system data server 430 that may access system-wide data from a driver/vehicle/system data store 435, as well as an output app 440 hosted on the mobile phones 130 of the drivers 122, 132, some or all of which may communicate via the communication network 450.

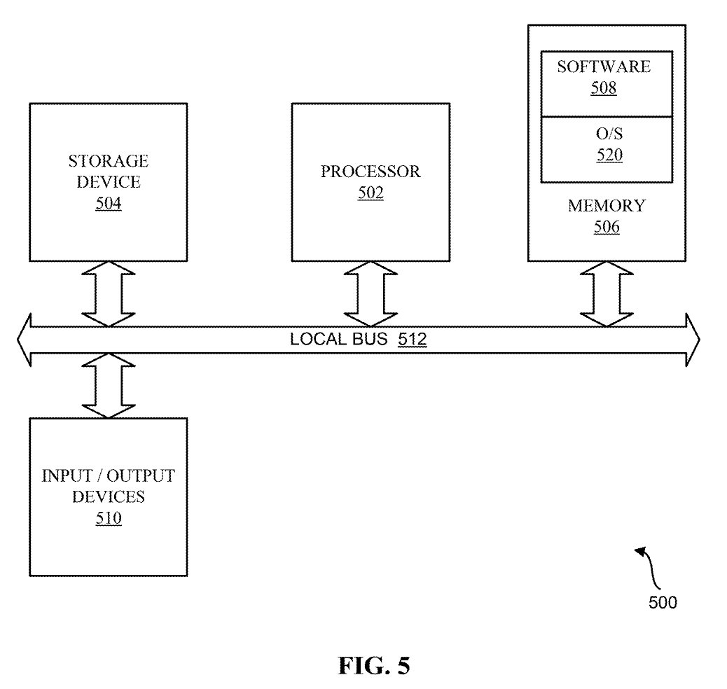

The present system for executing the functionality described in detail above may be one or more computers, an example of which is shown in the schematic diagram of FIG. 5. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Returning to FIG. 3, the central system 300 may operate upon a map implemented as a directed, connected graph G=(N;E) made up of nodes N and edges E. The edges correspond to streets within a pre-defined geographic area, and the nodes are a set including all intersections. Each edge eϵE has a cost cₑ which may be thought of as a sum of both the costs due to time spent along that edge wₑ, i.e. costs due to drivers wage rate, and costs due to distance traveled along the edge fₑ, i.e. costs due to vehicle fuel and maintenance costs. Therefore,

cₑ=wₑ+fₑ. (Eq. 1)

The system 300 may assume that costs of travel along a single edge are constant. If there is a discrepancy in cost per distance traveled along an edge, that edge may be split by preprocessing. Herein, the shorthand notation ‘xy’ refers to the directed edge from node x to node y, and the subscript ‘xy’ on another variable refers to a variable that corresponds to the edge ‘xy’; for instance Q_{xy} is a reference to a particular value of the edge ‘xy’. In addition, two variables are defined over the whole geographic space, the expected revenue from a pickup at a particular location Rₓ, and the expected time until a passenger request at a particular location Qₓ. This defines the expected value of waiting at a particular location until a ride request as follows:

V(x)=Rₓ−wₓ∫₀^{∞} [symbol] (Qₓ>t)dt (Eq. 2)

Then, the forecast module 340 calculates for each edge a variable Qₑ corresponding to the probability of a pickup during travel along that edge, i.e. the probability of a pickup occurring in the time it takes to transverse that edge along the edge path. Furthermore, the central system calculates a single revenue variable Rₑ, as the average revenue for a request received while traveling along edge e. When V (x) is calculated, the central system 300 preprocesses the map by adding a node at any point in the road network that contains a local maximum of V (⋅). For any node vϵV, let the set Cᵥ, a subset of all of the nodes N, be the set of children of node v, i.e. Cᵥ contains any nodes z such that ‘vz’ is an edge. Let Aᵥ be the corresponding set of edges connecting any such node v to its children. Then value of traveling down the edge is given by

V(xy)=R_{xy}Q_{xy}−c_{xy}+(1−Q_{xy})V̅(y) (Eq. 3)

where the value function at a node y is defined as

$$\overline{V} ( y ) = {max}_{a ∈ {A}_{y}} \{ V ( a ) , \underline{V} ( y ) \} \qquad ( Eq . 4 )$$

The variable V (y) is the value from stopping or waiting at a particular node, as explained above. While these values are derived and populated, the values W=max V(v) over vϵV and the corresponding nodes that maximizes this value are retained. Because nodes are inserted at inflection points, it is known in advance that the most valuable position in the graph is at that node that maximized V(v) over all nodes.

The routing module 360 may not apply a simple approach that compares the value of various paths, as this does not account for worst-case solutions. For example, due to loops in a traffic network, there may be an infinite number of possible paths (routes) starting at any given node.

However, the embodiments assume a solution exists that does not include a loop, narrowing the field of possible solutions, with beneficial properties, where the solution is provably optimal for the more general between-ride routing problem that the embodiments consider. That is, a solution method that considers an infinite number of possible paths starting at any given node could never find a better path then the one found by the embodiment.

The routing module 360 may assume P*(x) represents an optimal path starting at node x, and that for any xϵN, there exists some optimal path P*(x) that is a simple path, i.e., it visits every node at most once before waiting at a final node. This may be shown as follows:

An optimal path P′(x) is a (possibly infinite) sequence of nodes, starting at node x, that are visited in an optimal path. If it is assumed that P′(x) is an infinite sequence, then, since the set of nodes is infinite, there must be some node yϵN that P′(x) visits an infinite number of times. But that implies that any sub-path of P′(x) starting and ending at node y must have equivalent value, since they are all part of the choice set at y, i.e. if one loop was strictly more valuable than any other, it would never be chosen.

Therefore, the existence of optimal path P′(x) implies the existence of another optimal path P″(x) that has an infinitely repeated loop from node y to itself. It can be constructed by finding the first visit to node y in P′(x), and then appending the sequence (x, . . . y) from P′(x) with any loop from node y, repeated infinitely. This loop is defined as 1=(e₁, . . . eₙ) where e₁ starts at node y and eₙ ends at node y.

Since the expected waiting value V(x)≤W, it is bounded from above by the upper bound W and must attain a maximum on the chosen 1 from y. Let w represent the node along path 1 that maximizes V(x). But then an alternative viewpoint of the infinite sequence of loops is as an infinite sequence of loops through node w. But then, by definition of w as the node in loop 1 that maximizes V(x), then there must be a path P(x) that starts at node x and waits at node w once it is reached; this path has value at least as high as P′(x). Since P′(x) is optimal, then P(x) must also be optimal. Therefore, there is always an optimal routing solution with finite movement.

Next, the embodiments assume that P*(x) is a finite sequence of nodes that form an optimal path from node x. Some path meeting these characteristics must exist, as shown in the preceding step. The path P*(x) can have a finite number of finite-length loops. Consider an arbitrary such loop, starting an ending at node z. Since this loop can only be traveled a finite number of times, there must be some other path beginning at node z that does not contain a loop back through node z. Since this path, starting at z, is also chosen at node z, a path P″(x) that simply eliminates a loop through z must be at least as good as P′(x). Therefore, P*(x) is constructed by iterating through and eliminating all loops in the original path P′(x). P*(x) is at least as valuable as P′(x), hence it is optimal. Therefore, from any starting node xϵN, a non-looping optimal path P*(x) exists.

As per the previous proof, simple paths P may be described as a subset of all the nodes N, which represent points visited along the path. Notice that the order of points is not necessarily preserved, so the set description does not fully define a path. However, any path admits at most one representation as a set, so a path fully defines its set representation. The edge and node optimal values may be redefined as follows:

$$\begin{matrix}V ( xy , P ) = {R}_{xy} {Q}_{xy} - {c}_{xy} + ( 1 - {Q}_{xy} ) \tilde{V} ( y , P ) & ( Eq . 5 ) \\ \tilde{V} ( y , P ) = {max}_{a ∈ {A}_{y} ⋂ {P}^{c}} \{ \tilde{V} ( ya , P ⋃ \{ y \} ) , \underline{V} ( y ) \} & ( Eq . 6 )\end{matrix}$$

Where P is described above, P^{c}=N\P, and A_{y} represents the children of node y, i.e. nodes that have directed edges from node y.

The maximum value of any path from node y that does not contain any nodes in the set P, \tilde{V}(y, P) satisfies the recurrence:

$$\tilde{V} ( y , P ) = {max}_{a ∈ {A}_{u} ⋂ {P}^{c}} \{ \tilde{V} ( a , P ⋃ \{ y \} ) , \underline{V} ( y ) \} \qquad ( Eq . 7 )$$

with \tilde{V}(a, P∪{y}) defined as in Eq. 5. This may be demonstrated as follows.

Consider any simple path P that begins at arbitrary node x and that eventually reaches y. For any child aϵA_{y} of node y, the function \tilde{V} (a, P∪{y}) describes the value of traveling from y to a and then optimally onward from node a, by the definition in Eq. 5. Given the optimal paths forward for each child \tilde{V} (a, P∪{y}) and network parameters, the value of being at node y along the current path P must be at least as high as the value of any set of options moving forward. In the case where one such edge option is greater than or equal to the value of staying at that node, then \tilde{V} (y, P)=max of \tilde{V}(a, P∪{y}) over all nodes that are in both A_{y} and P^{c}. In the case where there is no valuable edge option, than the optimal value of arriving at the node is just the value of waiting at the node, i.e.

\tilde{V}(y,P)=V(y). (Eq. 8)

Due to the explanation above, it follows that evaluating \tilde{V}(y, { }) and returning the solution path produces an optimal path, where { } refers to the null set. Since this path is optimal, it must be at least as good as any path obtained by evaluating V (y). Therefore, it is sufficient to evaluate \tilde{V} (y,{ }) to find an optimal path starting at node y. Furthermore, since the set of nodes N is finite, then the algorithm is guaranteed to terminate. Calculating \tilde{V} (y, { }) and returning the optimal path used to calculate its value results in the optimal path for the between-rider driver 132 who is currently positioned at node y (where y is an arbitrary point on the map).

A process for finding the optimal value of any route from a starting node yϵV is given above. The routing module 360 may implement this process and return as an output details for the optimal path.

The worst-case complexity of a naive algorithm can be exponential in the number of nodes. Therefore, as applied here, the routing module 360 terminates the search for optimal paths by using knowledge of the highest value of any node in the system, i.e., an upper bound W=Vmax=max Vᵢ for iϵN, and discounting along a path due to the likelihood of a ride-request while traveling along that path, to set an upper limit on the required depth of the recursive search. This approach reduces time complexity while still guaranteeing optimality.

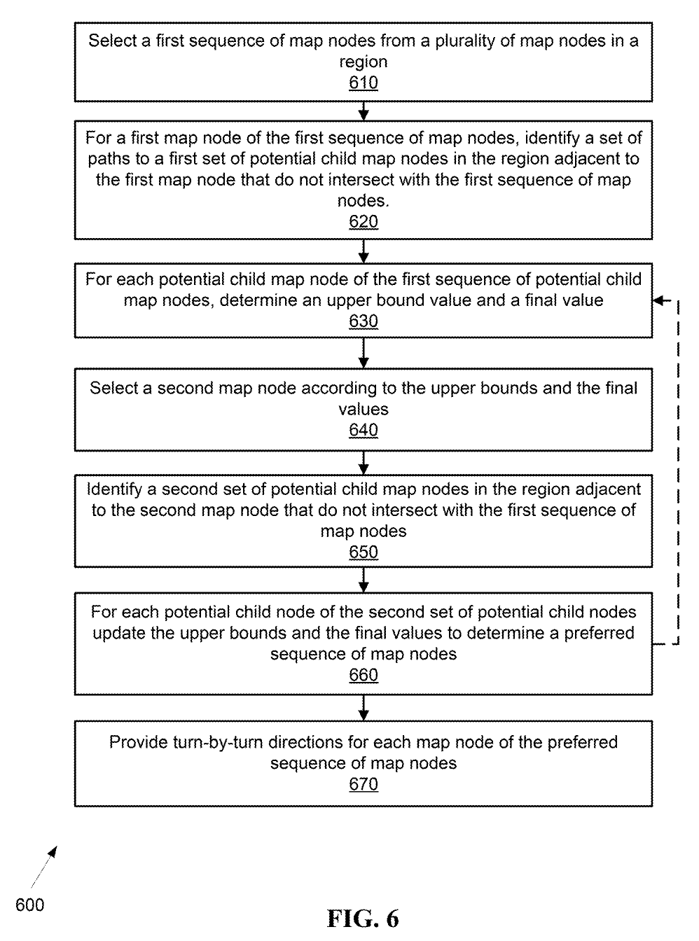

FIG. 6 is a flowchart 600 for an exemplary first method embodiment for implementing the functionality of the central system 300 (FIG. 3). It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

A first sequence of nodes P from a plurality of map nodes V in a region is selected, as shown in block 610. For a first map node c of the first sequence of map nodes, a set of paths to a first set of potential child map nodes A_{c} in the region adjacent to the first map node that do not intersect with the first sequence of map nodes P is identified, as shown by block 620, for example, edges from c to nodes in A_{c}\P^{c}. Assume a child map node upper bound value W (for all a in the set A_{c}\Pc, \tilde{V}(a, P∪{c})≤W)) and for each potential child map node a of the first sequence of potential child map nodes determine an upper bound W and a final value \tilde{V}, as shown by block 630.

A second map node is selected according to the upper bounds and the final values, as shown by block 640. A second set of potential child map nodes adjacent to the second map node is identified that do not intersect with the first sequence of map nodes, as shown by block 650. For each potential child node of the second set of potential child nodes the upper bounds W and the final values \tilde{V} are selected to determine a preferred sequence of map nodes, as shown by block 660. As shown by the dashed line indicating a recursive structure, block 660 generally provides feedback to block 630 to update the values of the nodes in the first set. Block 630 completes when block 660 is complete. Turn-by-turn directions comprising for each map node of the preferred sequence of map nodes a selected direction to a subsequent map node of the preferred sequence of map nodes are provided, as shown by block 670.

It should be noted that while the flowchart 600 describes iterating through a first and second set of child nodes, that the method may be extended through all potential sets of child nodes.

The following describes a second exemplary method embodiment to perform iterative updating from the first method embodiment. Instead of starting at the driver's node and branching out to the children, this approach starts at the most valuable node in the network and updates every parent of that node and then all of the parents of those nodes, successively. An exemplary second method embodiment presented here gives the optimal route for drivers from all starting vertices in worst-case O(NE) time, where N and E represent the set of nodes and edges in the road network graph. As a broad overview, the second method embodiment uses an iterative relaxation technique to find the optimal path for drivers. The technique of iterative relaxation is similar to the method used in the Bellman-Ford algorithm, but it is applied here as part of the presented solution for a graph that features positive values for both nodes and edges, which is outside the scope of the Bellman-Ford algorithm. Here the set of nodes N is obtained by taking the set of vertices in the road network graph, and adding nodes at any point in the road network that contains a local maximum value V_{stay}.

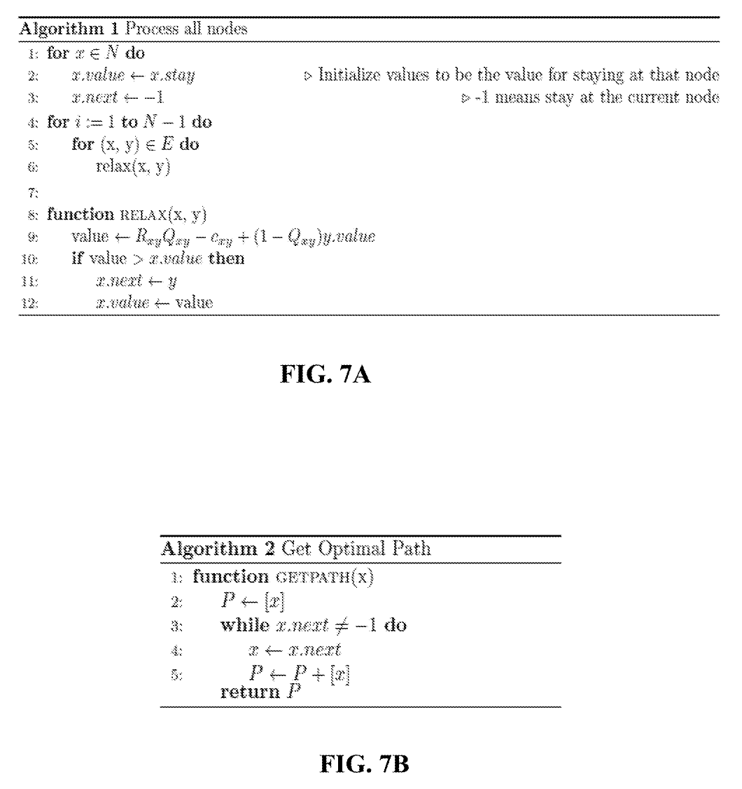

As per the first method embodiment, for any node x in N, there exists some optimal path P*(x) starting at node x that is a finite simple path. That is, P*(x) has finite length and does not pass through any vertex more than once. From this, it can be seen that for every starting node there is an optimal path of length at most |N|−1. FIG. 7A shows pseudocode for a first algorithm for processing all nodes under the second embodiment, defining x.stay=V_{stay}(x) as the value for staying at a particular node x.

The steps shown in FIG. 7A find the optimal next node to go for all nodes. After processing x.next values for all the nodes, and repeating this operation E times, where E is the number of edges, the optimal path for any starting node may be found using the GETPATH function (Algorithm 2), shown in FIG. 7B, which traverses the next nodes in order.

Algorithm 1 uses the principle of relaxing edges in order to iteratively find a better optimal value for each starting node. Algorithm 1 starts by initializing the value of each vertex V (x) to be V_{stay}(x). The process proceeds to relax all the edges, over N−1 iterations. During a relaxation of an edge (x, y), the value obtained for travel toy from x using Eq. 3 may be considered. If the obtained value is larger than the current best value found, V(x) and x.next may be updated.

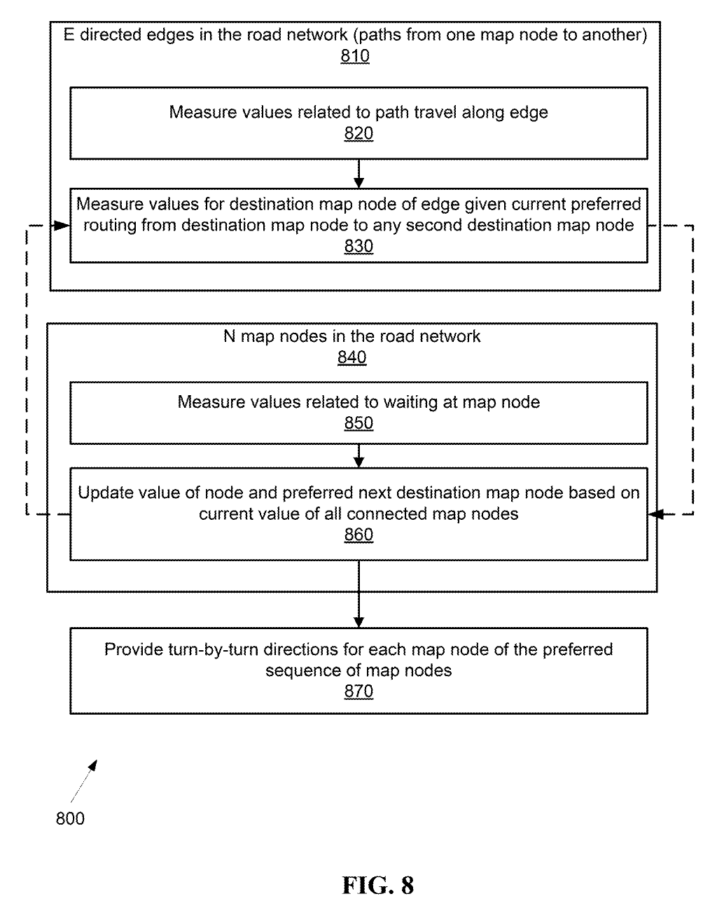

FIG. 8 is a flowchart 800 for the second method embodiment for implementing the functionality of the central system 300 (FIG. 3). Block 810 pertains to E directed edges in the road network, indicating paths from one map node to another. Values related to path travel along an edge are measured, as shown by block 820. Values for a first destination map node of an edge are measured given a current preferred routing from the first destination map node to any second destination map node, as shown by block 830.

Block 840 pertains to N map nodes. Values related to waiting at a map node are measured, as shown by block 850. Values of a map node and a preferred next destination map node are updated based on current values of all connected map nodes, as shown by block 860. The dotted lines indicate that the determination of preferred destination map nodes and map node values are performed iteratively. Turn by turn directions for each map node of the preferred sequence of map nodes are provided, as shown by block 870.

The second method embodiment provides a worst-case runtime of O(NE), since relaxing each edge takes constant time, and the second method embodiment performs O(NE) total relaxations in lines 4 and 5 of FIG. 7A. In practice however, there may be several heuristics that can be used to decrease the runtime. Firstly, the algorithm may be terminated if the values V(x) are unchanged after a full iteration. The runtime is then O(lₘₐₓE), where lₘₐₓ is the maximum length of an optimal path in the road network. This greatly reduces the runtime especially for large networks, since typically each optimal path only spans a fraction of the set of all nodes. Furthermore, after i iterations, the best path of length at most I may be obtained. In practice this is usually sufficient, since by the time a driver has driven through i nodes, the driver would likely have found the next passenger.

Another possible heuristic is to record the step number where the value of each node V(y) was last updated, as well as the step number where the last relaxation of each edge e was made. This way it may be possible to skip relaxing edge (x, y) if it has been relaxed once since the last update of V(y).

The embodiments described here take an open-ended approach to routing that does not explicitly use a destination when providing optimal turn-by-turn directions to a driver. Previous methods and systems have not provided turn-by-turn driving directions without a destination. Merely considering certain “ideal” destinations for a driver, and then calculating the optimal path towards those destinations may not provide optimality of the results unless it compares the value of traveling along an optimal path to any node in a transportation network, which is presumably slower to calculate and/or more computationally intensive. In contrast, the embodiments provide benefits over methods that calculates destination-specific optimal directions to some subset of nodes. The embodiments provide turn-by-turn directions that result in higher expected driver earnings than the previous methods.

Unlike previous systems, the embodiments are capable of adjusting directions if a driver goes off course in a preferred manner. For example, a system that simply compares routes to all destinations and picks the best destination may route towards the originally chosen destination in the event of a driver going off-route, even if that destination is no longer the most valuable course of action given the driver's new position.

Furthermore, while previous DP systems provide optimal policies in sequential decision problems, they have not provided efficient solutions to the turn-by-turn transportation routing problem. Under previous DP systems, the set of possible turn-by-turn two could include paths with loops, whereby the same decision point can be encountered multiple times. This case is not well-handled by the existing DP framework. The embodiments provide additional benefits over other possible solutions because they use the specific structure of a transportation network to upper-bound the value of certain paths, which helps reduce the run-time and makes it practical for commercial applications.

The embodiments here provide substantial benefits to TNC drivers and TNC companies. For instance, even if a driver is aware of peak prices in certain parts of the network, they cannot individually compute the value of each of the large number of possible paths through the network. Similarly, they cannot easily calculate if it is worthwhile (in terms of expected profit) to make large detours to areas with higher prices. On the other hand, this calculation can be much more effectively performed by the embodiments on a time-scale suitable to the needs of drivers. As such, the embodiments may be used to increase driver earnings while driving on a TNC platform.

Furthermore, the embodiments provide benefits to TNCs, like Uber, Lyft, or Didi, who may wish to license it for use in their existing driver applications. The embodiments provide more efficient routing directions to drivers, which increases the rate of pickups and platform revenues, and also reduce passenger wait times, which increases the value of the platform to passengers, and therefore their likelihood to continue using that platform. Finally, by improving the usefulness of existing driver capacity, implementation of the embodiments may reduce the need of TNCs to expand the number of drivers that use their platform, further reducing costs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for between-ride routing on a map for a driver of a vehicle of a transportation provider comprising:
a receiver configured to receive driver data from a driver communication device and passenger data from a passenger communication device of a prospective passenger via a communication network, wherein the driver data comprises a driver location and the passenger data comprises a prospective passenger location;
a storage device configured to store the driver data and passenger data; and
a server comprising a processor and a memory configured to store non-transient instructions that, when executed by the processor define:
a routing module configured to access the driver data from the storage device and a forecast output and to calculate a turn direction for the driver at a map node based on the driver location.

2. The system of claim 1, wherein the forecast output includes at least one of the group consisting of a ride request rate for a location, a driver flow, an indication of driver supply, an indication of driver demand, a ranking of locations based on demand, and a supply flexibility estimate.

3. The system of claim 2, further comprising a forecast module configured to access the driver data and passenger data from the storage device and provide the forecast output.

4. The system of claim 1, further comprising an output module configured to provide the turn direction to the driver.

5. The system of claim 4, wherein the output module is hosted as an application on the driver communication device.

6. The system of claim 5, wherein the application displays the turn direction to the driver via a graphical indication on a map.

7. The system of claim 5, wherein application provides the turn direction as an audio instruction and/or as text.

8. A machine executable method for between-ride routing for a driver of a vehicle of a transportation provider, comprising the steps of:
selecting a first sequence of map nodes from a plurality of map nodes in a region;
for a first map node of the first sequence of map nodes, identifying a set of paths to a first set of potential child map nodes in the region adjacent to the first map node that do not intersect with the first sequence of map nodes.
for each potential child map node of the first sequence of potential child map nodes determining an upper bound value and a final value;
selecting a second map node according to the upper bounds and the final values;
identifying a second set of potential child map nodes in the region adjacent to the second map node that do not intersect with the first sequence of map nodes;
for each potential child node of the second set of potential child nodes updating the upper bounds and the final values to determine a preferred sequence of map nodes; and
providing turn-by-turn directions comprising for each map node of the preferred sequence of map nodes a selected direction to a subsequent map node of the preferred sequence of map nodes.

9. The method of claim 8, further comprising the step of as each potential child map node is analyzed, updating the upper bound value and final value for each potential child map node of the first sequence of potential child map nodes.

10. The method of claim 8, further comprising the steps of:
receiving a ride request and a passenger location from a potential passenger;
receiving a driver characteristic for a driver of a vehicle; and
receiving a vehicle characteristic for the vehicle.

11. The method of claim 10, further comprising the steps of:
producing a ride request rate prediction for a map locations;
producing a driver flow prediction; and
producing a supply flexibility estimate.
based on a present location of the driver and one or more of the ride request rate prediction for map locations, the driver flow prediction, and the supply flexibility estimate, producing a route turn direction for a map intersection indicating a course to be taken by the driver at the map intersection.

12. A between-ride map routing device comprising:
a receiver configured to receive via a communication network a driver location;
a processor and a memory configured to store non-transient instructions that, when executed by the processor:
accesses the driver location and at least one of the group consisting of a ride request rate for a location, a driver flow, and a prospective passenger supply flexibility estimate; and
calculates a turn direction for a map node; and
a display configured to display the turn direction to the driver via a graphical indication on a map.

13. A machine executable method for between-ride routing for a driver of a vehicle of a transportation provider via a map comprising a plurality of edges and a plurality of nodes, wherein each node of the plurality of nodes comprises a node location and a node value, the method comprising the steps of:
identifying a first edge of the plurality of edges comprising a first origin node and a first destination node of the plurality of nodes; and
relaxing the first edge, wherein relaxing further comprises:
determining a proposed value for the first origin node based on the first destination node; and
updating the node value for the first origin node based on the proposed value.

14. The method of claim 13, further comprising the step of updating a proposed turn direction for the first origin node to indicate a direction to the first destination node from the first origin node.

15. The method of claim 13, further comprising the steps of:
identifying a second edge of the plurality of edges comprising a first origin node and a second destination node of the plurality of nodes; and
relaxing the second edge.

16. The method of claim 13, further comprising the step of identifying a preferred path from the first origin node, wherein the node location of the first origin node comprises a location of the driver.

17. The method of claim 13, further comprising the steps of:
identifying a third edge of the plurality of edges comprising a second origin node and a third destination node of the plurality of nodes; and
relaxing the third edge.

18. The method of claim 13, wherein the first node value comprises an expected driver profit relative to the first origin node.

19. The method of claim 13, further comprising the steps of:
providing turn-by-turn directions comprising for each map node a direction corresponding to an adjacent node of the plurality of nodes.

20. The method of claim 13, further comprising the steps of initializing the node value for each node of the plurality of nodes to indicate a preference to stay at the map node.
